(19) United States
(12) Patent Application Publication
(10) Pub. No.: US 2003/0163619 A1
(43) Pub. Date: Aug. 28, 2003

(54) Buffer controller and buffer control method

(75) Inventor: Keiji Saito, Tokyo (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/326,504

(22) Filed: Dec. 19, 2002

(30) Foreign Application Priority Data
Feb. 28, 2002 (JP) JP2002-052773

(51) Int. Cl. G06F 3/00

(52) U.S. Cl. 710/56

(57) ABSTRACT

A buffer controller and a buffer control method allow for communication stability and efficiency. In a master, an upper limit value is set for the number of buffers allocable to each of a plurality of links based on the number of buffers in a host controller and the number of established links through which data is to be transmitted. The host recalculates the upper limit value upon receiving a link-related event from the host controller. Alternatively or selectively, an upper limit value is set for the number of buffers allocable to each link based on the number of transmission buffers in a host controller and the number of established links through which data is to be transmitted that have a transmission request. The host recalculates the upper limit value upon receiving a link-related event or when the readiness status of a link changes.

### RELATED APPLICATIONS

This application is based upon and claims the benefit of priority from the prior Japanese Patent Application No. 2002-052773, filed Feb. 28, 2002, the entire contents of which are incorporated herein by reference.

### BACKGROUND OF THE INVENTION

1. Field of the Invention

The present invention relates to communication control for an electronic device, and more particularly, to buffer control in data transmission.

2. Description of the Related Art

As electronic devices have come to be in wide use in recent years, the wireless network technology that allows a plurality of electronic devices to more readily be interconnected in a network by radio has been under development. Bluetooth™ is one standard for such wireless connection. The Bluetooth standard operates in the 2.4 GHz radio spectrum and is mainly for short-range communication. One master (main) electronic device can be connected with a number of slave (sub) electronic devices.

According to the Bluetooth standard, a master-slave communication network is called “Piconet.” A link is established between the master side and slave side within the Piconet. There are two kinds of links used depending upon the kind of communication. These are the SCO (Synchronous Connection-Oriented) link and the ACL (Asynchronous Connection-Less) link.

In the field of wireless communication such as the master-slave communication, buffers are often provided in order to achieve stable and efficient communication. When a buffer is provided on the master side, transmission data can be stored in the buffer before the data is transmitted. The buffers are particularly useful in communication in the environment in which a plurality of links connect the master and a plurality of slaves.

The electronic device called “master” includes a host and a host controller. The host has various application software that requests communication to be carried out by the host controller. When a transmission request is issued from the host to the host controller, the software allocates buffers for data to be transmitted from the host, and the host controller stores the data in the buffers on the basis of a prescribed unit length.

Among the master-slave links, when the software in the master as a data transmission source issues communication requests through links to a number of slaves, buffer allocation in response to the requests must be controlled. According to a conventional allocation method for such control, the transmission requests are received one after another, and a buffer is allocated to a transmission source for each link for each request. This so-called round robin type buffer allocation is a simple control that allows empty buffers to be sequentially filled.

Buffer control is performed in fields other than wireless communications. For example, one technique as disclosed by Japanese Patent Laid-Open No. 10-124438 is related to conventional buffer control. This reference relates to a method of controlling data transfer buffers for links between various input/output devices and main memory, and according to the reference, more buffers are allocated to a device with a higher transfer rate among devices having different transfer rates. Stated differently, weighting is carried out depending on the transfer rates of the devices in the buffer allocation method.

In wireless communication, when the distance between devices fluctuates or the communication environment changes, the transfer rates dynamically change. The conventional buffer control takes little account of these dynamic fluctuations of the transfer rates in wireless communication. Furthermore, during wireless communication, physical links are sometimes lost because of changes in the wireless communication environment, and buffer allocation could be invalidated as a result. Present methods of buffer control, including the round robin type buffer allocation, do not adequately address such situations.

The round robin type buffer allocation also suffers from the following disadvantage. Assume that there are a number of links, and the host requests data to be transmitted through the links from data transmission sources. If the transfer rate of a link is significantly lower than the transfer rates of other links, a buffer is still automatically allocated to the link with the lower transfer rate. Therefore, the ratio of the number of buffers allocated to the link to the total number of allocable buffers increases. As a result, the number of buffers to be allocated to the other links with no transfer rate problem is reduced, so that the transfer rate of the system as a whole is decreased. In the worst case, the link with the lower transfer rate uses all the buffers, which could impede communication by the other links.

Thus, it is difficult to achieve buffer control allowing for the stability and efficiency of a system in which the transfer rates could dynamically change.

### BRIEF SUMMARY OF THE INVENTION

Embodiments of the present invention provide a buffer controller and a buffer control method allowing for system stability and efficiency.

Embodiments of the present invention provide a buffer controller including a control device configured to allocate a buffer to data to be transmitted through each of a plurality of links; and a setting device configured to set an upper limit value for the number of buffers to be allocated for each of the links. The control device allocates a buffer within a range not greater than the upper limit value set by the setting device. The setting device sets the upper limit value based on the total number of allocable buffers and one of either (1) the number of links through which data is to be transmitted, or (2) the number of links through which data is to be transmitted that have data ready to be transmitted.

Additional advantages of embodiments of the invention will be set forth in the description which follows. The advantages of embodiments of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram of the configuration of an electronic device according to embodiments of the present invention;

FIG. 2 is a schematic diagram illustrating master-slave communication according to embodiments of the present invention;

FIG. 3 is a diagram of an HCI data packet;

FIG. 4 is a diagram of an HCI event packet;

FIG. 5 is a schematic diagram showing counters and various parameters controlled by the host according to embodiments of the present invention;

FIGS. 6, 7, 8 and 9 are flowcharts for illustrating buffer control operation according to embodiments of the present invention; and

FIG. 10 is a diagram showing a specific example of how buffer allocation is carried out according to embodiments of the present invention.

### DETAILED DESCRIPTION OF THE INVENTION

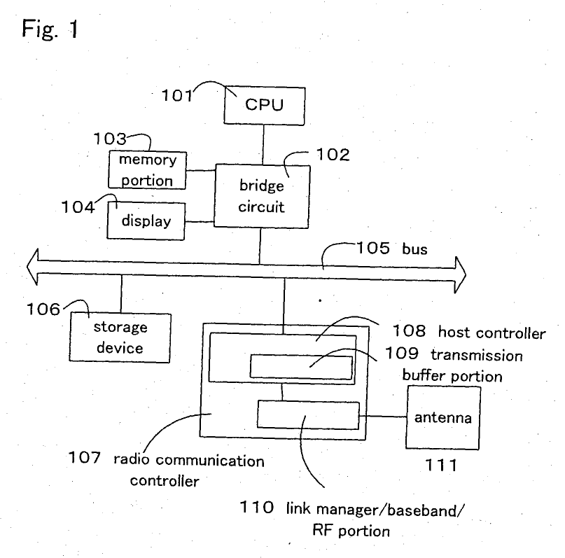

Embodiments of the present invention will now be described with reference to the accompanying drawings. FIG. 1 is a block diagram of the configuration of an electronic device operating as a master or a slave in a wireless communication system in which embodiments of the present invention may be employed. A CPU 101 is a processor that controls the operation of the electronic device. The CPU 101 and a bridge circuit 102 are connected. The bridge circuit 102 serves as a bridge between the CPU 101 and other circuits. The bridge circuit 102 is connected with a memory portion 103.

The memory portion 103 stores data used for operations by the CPU 101 and is used as a working area for developing various programs such as an operating system and application programs. The memory portion 103 stores various parameters and counter values used for buffer allocation control that will be described. The CPU 101 together with the memory portion 103 operate as a control device and also as a setting device in accordance with embodiments of the invention. The control device (or control means) is configured to allocate a buffer to data to be transmitted through each of a plurality of links. The setting device (or setting means) is configured to set an upper limit value for the number of buffers to be allocated for each link. The control device allocates a buffer within a range not greater than the upper limit value set by the setting device. In other words, once the number of allocated buffers for a particular link reaches the upper limit value, no more buffers are allocated to that link. In accordance with certain embodiments of the invention, the setting device sets the upper limit value based on the total number of allocable buffers and the number of established links through which data is to be transmitted (that is, the number of established links in the communication system through which data may be transmitted). Alternatively, or selectively, the setting device might set the upper limit value based on the total number of allocable buffers and the number of established links through which data is to be transmitted that have data ready to be transmitted.

The bridge circuit 102 is also connected with a display 104, and data processed by the CPU 101 can be shown in the form of an image or character information on the display 104. A liquid crystal display can be used as the display 104.

The bridge circuit 102 is also connected with a bus 105 in the electronic device. The bus 105 is preferably a high speed bus such as a PCI bus. The bus 105 is connected with a storage device 106 and a radio communication controller 107. The storage device 106 stores an operating system (OS) for the electronic device, various application programs, and processing programs to carry out embodiments of the present invention. The device may be a mass storage HDD (hard disc drive).

The radio communication controller 107 is connected with the bus 105 to receive data and is also connected with an antenna 111 for wireless transmission/reception. In one embodiment, the radio communication control is carried out based on the Bluetooth standard. A host controller 108 and a link manager/baseband/RF portion 110 are integrated in the radio communication controller 107. The host controller is also provided with a transmission buffer portion 109 having a plurality of transmission buffers.

In one embodiment, the transmission buffer portion 109 has seven buffers, each having a size of 339 bytes. The buffer size depends on the packet size according to the Bluetooth standard. The size of 339 bytes is adapted to the size of a packet type called DH5, which is the largest size ACL (Asynchronous Connection-Less) packet specified by the Bluetooth standard. The number of buffers provided as the transmission buffer portion 109 can be set as desired depending on the necessary reliability or cost of the system. The larger the number of the buffers, the less is the risk that the system will go down. On the other hand, the cost can be reduced when a smaller number of buffers is used.

Note that in the following description of the embodiments, the ACL link according to the Bluetooth standard will be used as an example. Unlike the ACL link, the SCO link is a type of connection adapted to line switching, single master-single slave communication, and therefore operates at a constant communication rate. On the other hand, the ACL link is a type of connection adapted to packet switching, and the communication rate is, therefore, often dynamically changed depending on the link. Therefore, embodiments of the present invention are usefully applied to the ACL link, but may also be applied to any suitable link or connection adapted to packet switching.

As will be described, the host controller 108 serves as an interface between a higher application (host) and a lower layer according to the Bluetooth standard such as a link manager layer and a baseband layer. The transmission buffer portion 109 stores transmission data from the host. The link manager/baseband/RF portion 110 is a semiconductor device that controls the link manager layer, the baseband layer and a physical layer according to the Bluetooth standard. Note that the link manager layer is defined as a protocol related to establishing or disconnecting communication links and security management for the communication links. The baseband layer is defined as a protocol that exchanges transmitted/received packets. The physical layer is defined as physical link characteristics (such as frequency).

The radio communication controller 107 is connected with the antenna 111 and carries out wireless communication through the antenna 111. The antenna 111 may be a chip antenna.

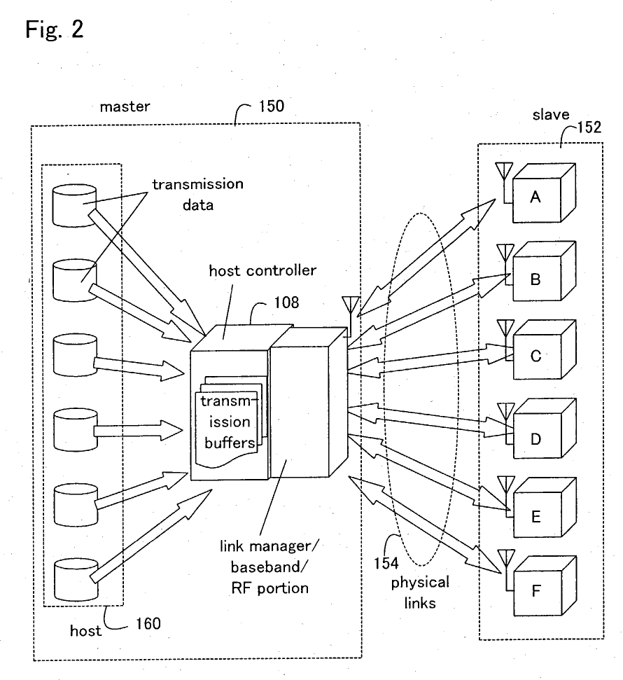

FIG. 2 is a schematic view showing the state in which the master side 150 is to transmit data to a plurality of slaves 152 (A to F) through physical links 154 (wire an/or wireless) provided to the slaves from the higher application serving as the transmission data source. In the following description of the embodiments of the invention, the word “host” refers to the host 160 on the master side 150 unless otherwise specified. The operation of the electronic device related to the embodiments will now be described with reference to FIGS. 1 to 5.

The host 160 transfers transmission data together with information to identify a slave and a link to be subjected to data transmission (Connection Handle) to a buffer in the host controller 108 from the memory portion 103. (The operation will hereinafter be referred to as “buffer allocation.”)

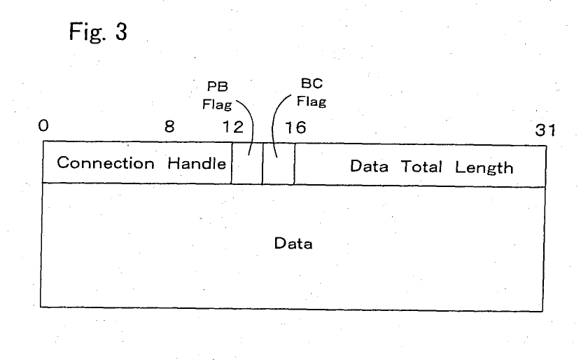

The buffer allocation is carried out on the basis of a packet called the HCI (Host Control Interface) data packet. The HCI data packet is defined by the Bluetooth standard and used for data exchange between the host and the host controller. According to embodiments of the present invention, the packet for the ACL type has a data format as shown in FIG. 3.

The first twelve bits of the HCI data packet are defined as the Connection Handle and used to identify the slave or link to which the HCI data packet is transmitted. The HCI data packet also includes a PB flag (Packet_Boundary_Flag) indicating whether the packet is the start data packet in a series of data packets and a BC flag (Broadcast_Flag) indicating whether the packet is for broadcasting transmission. In the HCI data packet, the Connection Handle and the various flags are followed by the Data_Total_Length, indicating the length of the data in bytes, and the data portion.

The host controls buffer allocations between links according to the control method that will be described. The host carries out the control such that the transmission buffer portion 109 does not overflow. More specifically, once buffer allocation to all the buffers of the transmission buffer portion 109 in the host controller 108 has been completed, the control stands by until there is an empty buffer in the transmission buffer portion 109.

The host controller 108 extracts data allocated within a buffer from the transmission buffer portion 109, specifies a destination slave based on the Connection Handle as described above, and transmits the data using the link manager and other corresponding lower layers.

The link manager/baseband/RF portion 110 transmits the received transmission data to the destination slave through the link via the antenna 111. The operation of the link manager, baseband and RF portion is based on the Bluetooth specification. The host controller 108 empties the buffer allocated to the link through which the transmission has been completed so that new data may be stored therein. The host controller 108 notifies the host of an event such as normal transmission completion or an event such as link disconnection caused by timeout or poor radio communication environment, as the case may be.

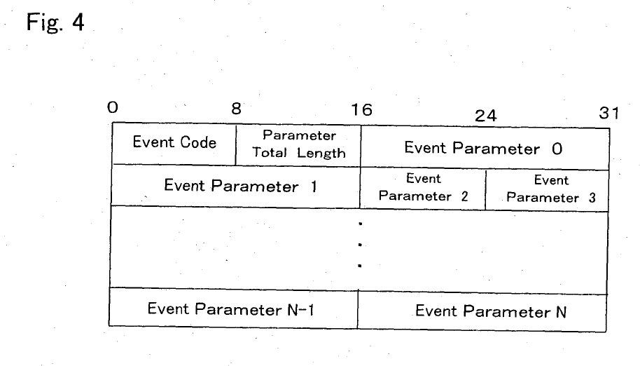

These events are HCI events and are disclosed in the published specification of the Bluetooth standard. The host controller transmits an HCI event packet indicating a corresponding event to the host. The HCI event packet has a data format as shown in FIG. 4.

The first byte of the HCI event packet is defined as an Event_Code and indicates which event the packet corresponds to. The byte following the Event_Code is defined as a Parameter_Total_Length indicating the length of all the parameters included in the HCI event packet. The portion following the Parameter_Total Length portion contains various parameters.

Among many events defined as HCI events, the following two events are of particular relevance to embodiments of the present invention. One is an event transmitted to the host from the host controller 108 upon normal transmission completion and defined as a Number_Of Completed_Packets event. With this event, the host controller 108 notifies the host of the number of packets that have been transmitted to the slave side. In response to the event, the host identifies the number of empty buffers in the transmission buffer portion 109 in the host controller 108. As will be described, this is an event related to the parameters for buffer control.

The other is an event indicating disconnection of a master-slave link and defined as a Disconnection_Complete event. With this event, the host controller 108 notifies the host of the completion of disconnection of a master-slave link caused by a request from the host or for some other reason. As will be described, this also is an event related to the parameters for buffer control.

Upon receiving the above events from the host controller 108, the host determines whether there is an empty buffer or not. If the host determines that there is an empty buffer, then the host determines whether there is other data to be transmitted. When there is data to be transmitted, the host carries out new buffer allocation and continues the data transmission.

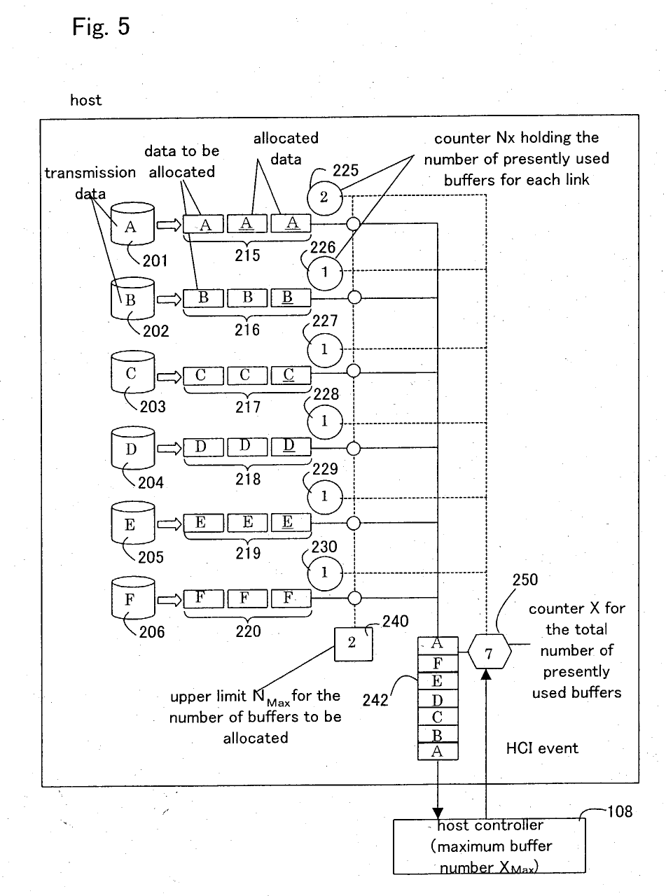

Referring to FIGS. 5 to 11, a specific operation of a first embodiment will be described. FIG. 5 shows various parameters for the host and host controller 108 held by the host. These transmission data, counters, and various parameters are stored in a prescribed region of the memory portion 103 shown in FIG. 1, while in FIG. 5, they are more schematically expressed for ease of illustration of the relation between the parameters.

In the example shown in FIG. 5, there are six transmission targets (slaves) A to F to which data may be transmitted. Storage units 201 to 206 store data to be sent to slave units A to F, respectively. Files 215-220 constitute data already allocated to a buffer 242 or data to be allocated to the buffer 242. Buffer 242 within host 160 is a software representation of a buffer that is configured as hardware within host controller 108. Assume that the total number of allocable buffers in the transmission buffer portion 109 in the host controller 108 is Xₘₐₓ. This number is the total number of allocable buffers according to the present embodiment. As will be described, to obtain the total buffer number Xₘₐₓ, the host transmits a command to read the number of buffers at initialization. The host transmits the command, then receives a packet including information related to the number of buffers from the host controller 108, and stores the number Xₘₐₓ in the memory portion 103.

The host distinguishes data after buffer allocation from data yet to be subjected to buffer allocation. In files 215 to 220 in FIG. 5, the underlined data A to F has been allocated to buffer 242, and the data A to F in files 215 to 220 with no underline is yet to be allocated to buffer 242.

The host is provided with counters 225 to 230 to hold the number of transmission buffers presently used by each link to a corresponding destination slave A to F. (Hereinafter the counter value will be referred to as Nₓ.) The host is also provided with a counter 240 to indicate the upper limit for the number of buffers allocated to each link. (Hereinafter the counter value will be referred to as Nₘₐₓ.)

The host is also provided with a counter 250 to indicate the number of buffers presently used. (Hereinafter the counter value will be referred to as X.) The value X is incremented/decremented according to HCI events from the host controller 108 as will be described. By the definition of the parameters, X equals the sum of Nₓ, i.e., the sum of counters 225 to 230.

The host sequentially transmits data after buffer allocation as an HCI data packet to the host controller 108. The A, B, C, D, E, F and A in the software buffer 242 in FIG. 5 are arranged in the sequence in which these data segments have been allocated to the software buffer 242 and transmitted to the hardware buffer 109 in the host controller 108 by the host 160.

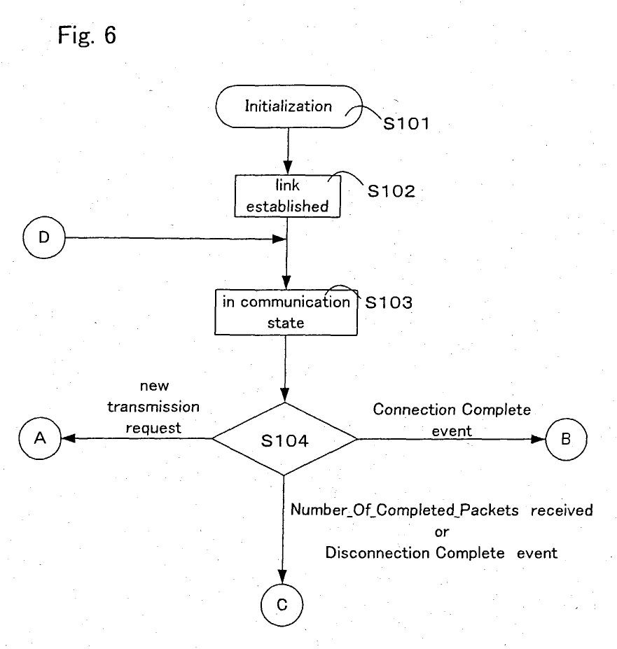

FIGS. 6 to 10 are flowcharts illustrating the flow of the operation of the buffer controller according to embodiments of the invention. Assume that the system in the electronic device has already been activated, and hardware or the like related to communication has already been initialized. Assume then that in this state, a certain communication request is issued. Assume further that at initialization there are as yet no established links through which data may be transmitted.

Referring to FIG. 6, the flow as a whole will be described. The host determines the size of buffer 109 (FIG. 1) in the host controller 108 at initialization (S101). At initialization, the host transmits an HCI_Read_Buffer_Size command to the host controller 108, and the host controller 108 in response returns information related to the buffer size. In the example according to the present embodiment, the host controller 108 returns the answer “seven buffers, each having a size of 339 bytes.” The host stores the obtained information related to the buffer size in the memory portion 103. In the present example, the number “7” is stored in the memory portion 103 as the total number of allocable buffers Xₘₐₓ of the transmission buffer portion 109. If the operation takes place directly after the initialization, the values in the other counters and the value of Nₘₐₓ are still all “0.”

Then, the host establishes a link for the issued communication request (S102). As an example, assume that the established link is the link for data A in FIG. 5. The link is established according to the Bluetooth standard.

The host carries out calculations for buffer allocation after establishing the link. For buffer allocation of transmission data for the link for data to slave A, the host carries out the following calculation. At the time of calculation, the number of established links through which data is to be transmitted is n, and the value Nₘₐₓ is calculated using n and the above Xₘₐₓ according to one of the following equations:

Nₘₐₓ=Int|Xₘₐₓ/n| (for Xₘₐₓ % n=0) Equation (1)

(If Xₘₐₓ<n, then Nₘₐₓ=1)

Nₘₐₓ=Int|Xₘₐₓ/n|+1 (for Xₘₐₓ% n not=0) Equation (2)

(If Xₘₐₓ<n, then Nₘₐₓ=1)

The operator % indicates obtaining the remainder after division. For example, 5% 2=1. Int|Xₘₐₓ/n| indicates extraction of the integer part of |Xₘₐₓ/n|. For example, Int|1.55|=1. If Xₘₐₓ is less than n (that is, if there are more links than buffers), then Nₘₐₓ is equal to 1. For example, if Xₘₐₓ=3 and n=4, then Nₘₐₓ=1.

According to the present example, the number of established links through which data is to be transmitted is 1 (n=1) at S102, and the total number of allocable buffers Xₘₐₓ is 7. In this case, Equation (1) is used because Xₘₐₓ % n=0. Thus, Nₘₐₓ=Int|7/1|=7.

After establishing the link and finishing the calculation, the host moves into a communication state (S103). Just after initialization, because buffers are not yet allocated, no communication is carried out. After buffers are allocated, as will be described, the host carries out communication (from D to S103). The communication through the link is carried out, for example, according to the Bluetooth standard.

Here, depending upon a prescribed set condition, the flow may branch into three different paths (S104). Branching takes place when either a transmission request is issued by the host to an already established link, the host receives a Connection Complete event (establishment of a new link), or the host receives a Number_Of_Completed_Packets event (completion of packet transmission) or a Disconnection Complete event (disconnection of a link). Note that these branching conditions or events are generated asynchronously. As will be described, when the host waits for a buffer to be emptied, a transmission request to an already established link is repeated, and therefore upon contention the other two conditions have priority over the condition that a transmission request is issued by the host to an already established link.

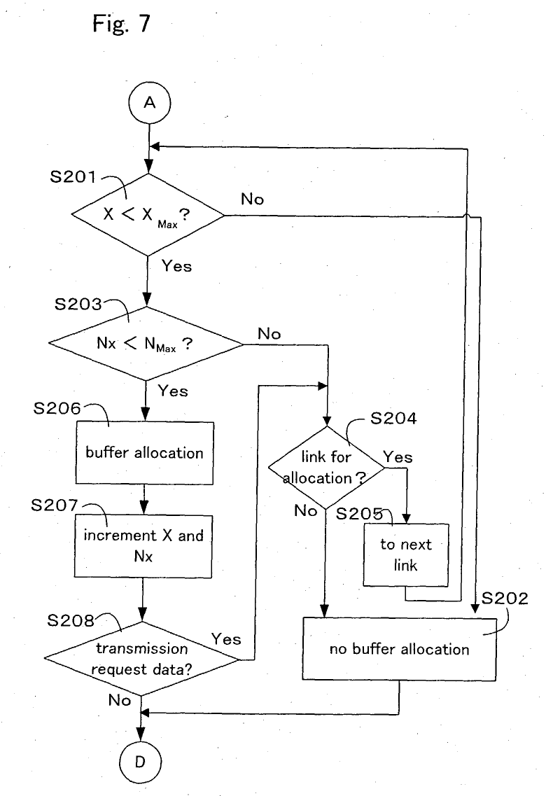

The condition that a transmission request is issued by the host to an already established link (from S104 to A) will be described with reference to FIG. 7. The host receives the transmission request and determines whether the number of presently used buffers X (the value of counter 250) is smaller than the maximum buffer number Xₘₐₓ (S201). Here, if the number of presently used buffers X is equal to the maximum buffer number Xₘₐₓ, which means the absence of an empty buffer, buffer allocation is not carried out (from No in S201 to S202). The control directly returns to the flow in FIG. 6 and waits for a buffer to be emptied (from S202 to D).

If the number of presently used buffers X is smaller than the maximum buffer number Xₘₐₓ, the host compares the number of buffers Nₓ allocated to the link to which data is to be transmitted, and the upper limit Nₘₐₓ for the number of allocable buffers for each link (from S201 to S203). Here, if Nₓ is smaller than Nₘₐₓ for the link of interest, the host allocates a buffer to the link (from Yes in S203 to S206). The host then increments the total number of buffers presently used (X) by 1 because one buffer has been allocated. Thus, counter 250 increments by 1. The host also increments by 1 the counter of Nₓ, for the link to which the buffer is allocated (S207), i.e., one of the counters 225 to 230.

After thus incrementing the counter values, the host determines if there is any other data to be transmitted (S208). If there is no such data, the control returns to the flow in FIG. 6 (from No in S208 to D). When there is data to be transmitted, the control proceeds to S204, and the buffer allocation process is repeated (from Yes in S208 to S204).

If it is determined in S203 that Nₓ is equal to Nₘₐₓ (Nₓ is never larger than Nₘₐₓ by definition), the host does not carry out buffer allocation to a link, and instead checks links through which other data is to be transmitted, and determines if any of the links through which data is to be transmitted have buffers that can be allocated (from No in S203 to S204). The checking is carried out by the comparison between the values of Nₓ and Nₘₐₓ in S203. If, as a result of checking all the links, it is determined that none of the links permit buffer allocation, then, in that case, there is no buffer allocation (from No in S204 to S202). In that case, the control returns to the flow in FIG. 6 and waits for a buffer to be emptied (from S202 to D).

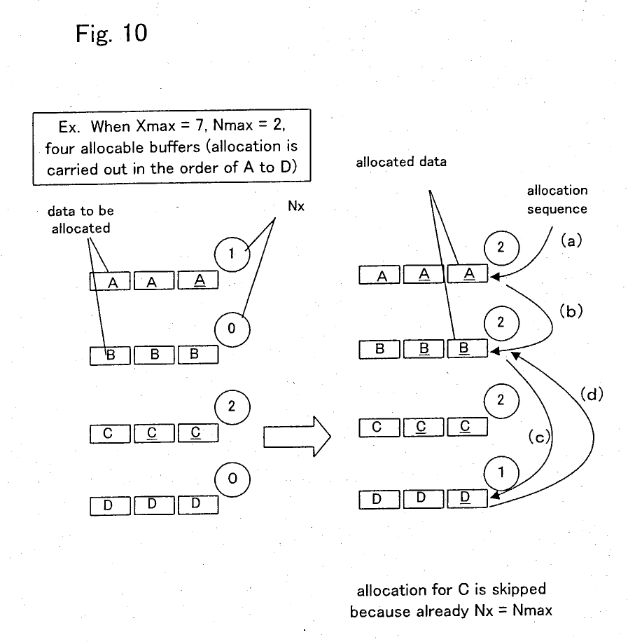

When it is determined in S204 that there is still a link that has buffers that can be allocated, the host proceeds to the link to which the next data is transmitted (from Yes in S204 to S205). The above-described processing is then performed for the next link (from S205 to S201). Thus, in this manner, buffers are allocated. A specific example of allocation will later be described with reference to FIG. 10.

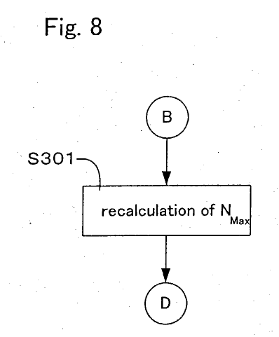

Now, the condition that the host receives a Connection Complete event in S104 in FIG. 6 will be described (from S104 to B). The event means that a new link has been established. In other words, the number of links to which a buffer may be allocated has increased. In this case, for communication stability and efficiency, Nₘₐₓ is recalculated. This will be described with reference to FIG. 8.

The Connection Complete event is one of the events defined in the specification of the Bluetooth standard. If, for example, the host is to establish a new master-slave link, the host transmits a Create_Connection command to the host controller 108. After receiving the command, the host controller 108 notifies the host of a Connection Complete event when a master-slave link is successfully established.

When the host controller 108 notifies the host of the Connection Complete event, the host recalculates Nₘₐₓ (from B to S301). The value of n is changed to a new value (n+1) and one of Equations (1) or (2) above is used for the recalculation of Nₘₐₓ, depending on the result of Xₘₐₓ % n. After the recalculation, the host stores the value of Nₘₐₓ in the memory portion 103. If a transmission request is issued after this, the host carries out the buffer control processing as shown in FIG. 7 based on the new Nₘₐₓ.

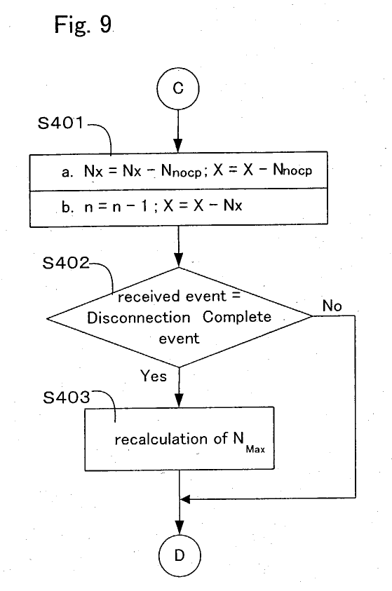

The condition that the host receives a Number_Of_Completed_Packets event (completion of packet transmission), or a Disconnection Complete event (disconnection of a link) will be described with reference to FIG. 9. These events indicate, respectively, that a buffer is emptied as a number of packets has been transmitted, or that the number of links is reduced by the disconnection of a link (which also results in a corresponding buffer or buffers being emptied).

The host controller 108 periodically transmits the Number_Of_Completed_Packets event to the host while it holds data to be transmitted to the transmission buffer portion 109. The event is defined in the specification of the Bluetooth standard, and notifies the host of the transmission destinations (and corresponding links) and the number of the packets that have been transmitted from the host controller 108 for a prescribed period.

When a master-slave link is disconnected, the host controller 108 transmits a Disconnection_Complete event and notifies the host of information about where the disconnected link was connected and about the cause of the link disconnection. The link disconnection takes place in response to a command from the master to the host controller to disconnect the link, or when the link is disconnected by some physical cause.

Upon receiving these events (from S104 to C in FIG. 6), the host recalculates parameters related to the buffer control (S401 in FIG. 9). Specifically, as shown in S401 a, upon receiving a Number_Of_Completed_Packets event, the host decrements Nₓ for the corresponding link and the value of X depending upon the link indicated in the event and the number of packets transmitted to the link. For example, if a particular number of packets in the buffers allocated to link A have been transmitted to the link from the host controller 108 such that one such buffer is emptied, the value of Nₓ for link A will be decremented by the number of completed packets (N_{nocp}) The value X will also be decremented by N_{nocp} because the total number of allocated buffers in the system has been decreased by N_{nocp}. On the other hand, as shown in S401b, upon receiving a Disconnection_Complete event, the host disconnects the link, and the number of links n is decremented by 1. In addition, the value X will be decremented by the value of Nₓ for the link indicated in the event.

The host then determines whether the received event is a Disconnection_Complete event (S402). If the received event is not a Disconnection_Complete event, in other words, if it is a Number_Of_Completed_Packets event, the control directly returns to the original flow (from No in S402 to D). If a transmission request is issued after this, the host carries out the buffer control processing as shown in FIG. 7 based on the new values of Nₓ and X.

If the received event is the Disconnection_Complete event, the host recalculates Nₘₐₓ as the number of links n is reduced (S403). The value of n is changed to the value of n resulting from the reduction in the number of the links and one of Equations (1) or (2) above is used for the recalculation of Nₘₐₓ, depending on the result of Xₘₐₓ % n. After the host thus carries out the recalculation, the control returns to the original flow (from S403 to D).

As described above, the host carries out the buffer control in response to a transmission request or various events. A specific example of the allocation process flow shown in FIG. 7 will now be described with reference to FIG. 10. In the embodiment shown in FIG. 10 according to which the value of Xₘₐₓ is 7, there are four established links. According to Equation (2), the value of Nₘₐₓ=(Int|7/4|+1)=2. Assume that one buffer is allocated to the link A and that two buffers are allocated to the link C (in the left side of FIG. 10). Thus, 3 of the 7 buffers have already been allocated (X=3). The round robin sequence of the links is A, B, C, D and A.

In the example shown in the right side of FIG. 10, there is a transmission request from each link, and there are four allocable buffers remaining. The allocation is carried out in the sequence of (a), (b), (c), and (d) shown by the arrows on the right side of FIG. 10. More specifically, the condition X (S201 in FIG. 7), and the condition Nₓ (S203 in FIG. 7) are checked for link A, to which data is to be transmitted. Because both conditions are satisfied, that is, because X<Xₘₐₓ and Nₓ<Nₘₐₓ, buffer allocation is carried out for link A (S206 in FIG. 7). Thus, after another buffer is allocated to link A (S206 in FIG. 7), the values X and Nₓ are both incremented by 1 (S207 in FIG. 7). Thus, X=4 and Nₓ=2 for the link A ((a) in the allocation sequence shown on the right side of FIG. 10).

After the buffer allocation to the link A, the host checks for the presence/absence of transmission request data (S208 in FIG. 7). Because all the links have transmission request data in the present example, it is then determined whether or not any of the remaining links permit buffer allocation (from Yes in S204 in FIG. 7). Because there are additional links permitting buffer allocation, the control proceeds to the next link B (from Yes in S204 to S205 in FIG. 7).

The same processing is carried out for the link B. More specifically, because X <Xₘₐₓ and Nₓ<Nₘₐₓ (X=4; Nₓ=0), buffer allocation is carried out for link B. After the allocation, the value X is 5, and the value Nₓ is 1 for the link B ((b) in the allocation sequence). Because there are additional links permitting buffer allocation, the control proceeds to the next link C. The value Nₓ for link C is already 2 (Nₓ=Nₘₐₓ). Therefore, a buffer is not allocated to the link C, and the control proceeds to the next link (from No in S203 to Yes in S204 and to S205 in FIG. 7).

The same processing is carried out for the link D. More specifically, because X <Xₘₐₓ and Nₓ<Nₘₐₓ (X=5; Nₓ=0), buffer allocation is carried out for link D. After the allocation, the value X is 6, and the value Nₓ is 1 for the link D ((c) in the allocation sequence).

Because there are additional links permitting buffer allocation, the control proceeds again to the next link A. The value Nₓ for link A is already 2 (Nₓ=Nₘₐₓ). Therefore, a buffer is not allocated to the link A.

Because there are additional links permitting buffer allocation, the control proceeds again to the next link B. The same processing is carried out for the link B. More specifically, because X<Xₘₐₓ and Nₓ<Nₘₐₓ (X=6; Nₓ=1), buffer allocation is carried out. After the allocation, the value X is 7, and the value Nₓ is 2 for the link B ((d) in the allocation sequence). At this point, the value X has reached 7 which is equal to the value Xₘₐₓ, and therefore the host ends the buffer allocation (from No in S201 to S202 in FIG. 7).

The buffer controller and the buffer control method as described above can improve the transfer rate of a system as a whole, if the master-slave transfer rate dynamically changes in the system. In addition, in the communication environment in which a physical link could be lost during communication, the transfer rate of the system as a whole can be improved while reducing the effect of the loss of the link. The features are particularly useful in the Bluetooth, and more generally useful to any multi-point communication system including a single master and a plurality of slaves as described above.

The first embodiment described above may be suitable for normal reliability communication systems. A normal reliability communication system is defined herein as a communication system in which it can be safely assumed that only one of the system's links may develop a problem that impedes communication, for example a transfer rate problem, at any given time.

A second embodiment of the invention will now be described. The second embodiment may be suitable for low reliability communication systems. A low reliability communication system is defined herein as a communication system in which it is likely that more than one of the system's links may develop a problem that impedes communication, for example a transfer rate problem, at any given time.

In the second embodiment, the configuration of the electronic device is the same as that of the first embodiment and the operation proceeds in the same manner as described above for the first embodiment with reference to the flowcharts shown in FIGS. 6 to 9. The second embodiment differs from the first embodiment in the method of calculating Nₘₐₓ. When there are n established links through which data is to be transmitted, the Nₘₐₓ for each link is calculated according to the following equation:

Nₘₐₓ=Int|Xₘₐₓ/n| (If Xₘₐₓ<n, then Nₘₐₓ=1) Equation (3)

Int|Xₘₐₓ/n| indicates extraction of the integer part of |Xₘₐₓ/n|.

According to the second embodiment, Equation (3) is used whether or not there is a remainder after division. In other words, Nₘₐₓ is equal to the quotient of the division regardless of the value of the remainder. For example, if Xₘₐₓ=7 and n=3, then Nₘₐₓ=Int|7/3|=2. The remainder of 1 is disregarded.

Using Equation (3), it is possible that not all available buffers will be used. However, the second embodiment has the advantage that even if one or more links have a problem that impedes communication at any given time, communication by the other links may not be impeded because there will be at least one other available buffer. As an example of the operation of the second embodiment, if Xₘₐₓ=4 and n=3, then, according to Equation (3), Nₘₐₓ=Int|4/3|=1. Thus, there are 4 buffers and 3 links, each link having an Nₓ of 1. Because each link has an Nₓ of 1, it is possible that one of the four buffers may not be used. If, however, one or more of the links has a problem that impedes communication, there will be at least one other available buffer that may be used such that communication is not impeded for the remaining links.

A third embodiment of the invention will now be described. The third embodiment may be suitable for a very high reliability communication system. A very high reliability communication system is defined herein as a communication system in which there is a very low probability that any of the system's links will develop a problem that impedes communication, for example a transfer rate problem.

In the third embodiment, the configuration of the electronic device is the same as that of the first and second embodiments and the operation proceeds in the same manner as described above for the first embodiment with reference to the flowcharts shown in FIGS. 6 to 9. The third embodiment differs from the first and second embodiments in the method of calculating Nₘₐₓ. When there are n established links through which data is to be transmitted, the Nₘₐₓ for each link is calculated according to the following equation:

Nₘₐₓ=Xₘₐₓ−1 Equation (4)

Using Equation (4), the number of buffers allocated to a link may be increased. If, for example, one of a plurality of links develops a problem that impedes communication, there will be at least one remaining buffer that can be used to maintain communication between the remaining links and their respective slaves. Unlike in the second embodiment where it is possible that not all of the buffers will be used, the third embodiment uses all of the buffers.

Although according to Equation (4) the integer 1 is subtracted from Xₘₐₓ, any integer value x greater than 0 and less than Xₘₐₓ may be used. The integer value used may be determined based on a balancing between the effective use of buffers and the stability of communication with each link.

A fourth embodiment of the invention will now be described. The fourth embodiment may be suitable when the communication system includes a priority communication link (hereinafter “priority link”). A priority link is defined herein as a link having priority, in terms of communication efficiency and stability, over the remaining communication links in the system. Like the third embodiment, the fourth embodiment may be suitable for a very high reliability communication system.

In the fourth embodiment, the configuration of the electronic device is the same as that of the previous embodiments and the operation proceeds in the same manner as described above for the first embodiment with reference to the flowcharts shown in FIGS. 6 to 9.

According to the fourth embodiment, the upper limit value Nₘₐₓ for the number of buffers allocated to a priority link is set according to Equation (4). For the remaining links in the system, the upper limit value Nₘₐₓ is set according to any of Equations (1), (2) or (3).

Unlike in the third embodiment where the number of buffers allocated to each link is increased by the same amount using Equation (4), in the fourth embodiment the priority link is allocated more buffers than the remaining links in the system. If there is a problem with the priority link that impedes communication, for example a transfer rate problem, there will still be at least one remaining buffer that can be used to maintain communication between the remaining links and their respective slaves. That is, the one remaining buffer may be shared by the remaining links. Thus, communication between the remaining links and their respective slaves may continue.

Note that the priority link may be specified by the user, or a communication link initially set by the host may automatically be the priority link. In addition, similarly to the third embodiment, although according to Equation (4) the integer 1 is subtracted from Xₘₐₓ, any integer value greater than 0 and less than Xₘₐₓ may be used.

In the embodiments described above, the parameter n is defined as the total number of established links in the communication system to which data is to be transmitted. Thus, the setting device sets the upper limit value of the number of buffers to be allocated for each link (Nₘₐₓ) based on the total number of allocable buffers (Xₘₐₓ) and the total number of established links through which data is to be transmitted. However, in alternative embodiments, the parameter n may be defined as the total number of established links having a transmission request at the time of recalculation. In other words, n is the number of links that have data ready to be transmitted. Thus, in these embodiments the setting device sets Nₘₐₓ based on Xₘₐₓ and the number of established links through which data is to be transmitted that have data ready to be transmitted.

This second definition of n may result in a more efficient communication system. To illustrate this point, assume that for a particular communication system Xₘₐₓ is 7 and that there are five established links, A, B, C, D and E. Assume further that links C, D and E do not have data ready to be transmitted at the time of recalculation. Using Equation (2) and the first definition of n, Nₘₐₓ=Int|7/5|+1=2. Thus, each of the five links are allocated a maximum of 2 buffers. In contrast, using Equation (2) and the second definition of n, Nₘₐₓ=Int|7/2|+1=4. Thus, the two links that have data ready to be transmitted (A and B) are allocated a maximum of 4 buffers and the links C, D and E which have no data ready for transmission, are not allocated any buffers.

It can be seen that there may be an increase in performance and efficiency of the communication system resulting from the fact that only the links that have data ready to be transmitted (A and B) are included in the recalculation. Thus, the buffers that are not needed by the links that do not have data ready to be transmitted (C, D and E) are available for use by those links that do.

If the readiness status of any of the links changes (that is, if at some point C, D and/or E have data ready to be transmitted or if A and/or B no longer do), a recalculation may be done at that time to update the value of n. It can be seen, then, that using the second definition of n, recalculation may have to be performed more often.

Therefore, in choosing between the first and second definitions of n, a developer or user, for example, may have to balance the increase in performance and efficiency of the communication system against the desirability of more stability resulting from fewer recalculations of Nₘₐₓ. In one embodiment, both definitions of n may be incorporated in the communication system and may be selectable based on, for example, the use of the communication system or the particular environment in which it is used.

Furthermore, the above-described embodiments or combinations thereof may be selectable by, for example, a developer of the communication system. More specifically, the particular Equations or combinations of Equations described above may be selectable for a communication system incorporating a buffer controller and buffer control method according to embodiments of the present invention.

In the description of the above embodiments, the wireless communication is based on the Bluetooth standard. However, the buffer controller and buffer control method according to embodiments of the present invention may be implemented in other wireless communication standards or wired communications.

Thus, embodiments of a buffer controller and a buffer control method allowing for communication stability and efficiency has been described.

What is claimed is:

1. A buffer controller for allocating buffers to a plurality of links, comprising:
a setting device configured to dynamically set an upper limit value for a number of buffers to be allocated for each of the plurality of links; and
a control device configured to allocate buffers to each of the plurality of links, the control device allocating a buffer within a range not greater than the upper limit value set by the setting device.

2. The buffer controller according to claim 1, wherein the setting device sets the upper limit value according to one of the Equations:
Nₘₐₓ=Int|Xₘₐₓ/n| (for Xₘₐₓ % n=0)
(If Xₘₐₓ<n, then Nₘₐₓ=1), and
Nₘₐₓ=Int|Xₘₐₓ/n|+1 (for Xₘₐₓ % n not=0)
(If Xₘₐₓ<n, then Nₘₐₓ=1);
wherein Nₘₐₓ is the upper limit value, Xₘₐₓ is a total number of buffers to be allocated, n is either (1) the number of links through which data is to be transmitted, or (2) the number of links through which data is to be transmitted that have data ready to be transmitted, the operator % indicates obtaining the remainder of the division Xₘₐₓ/n, and Int|Xₘₐₓ/n| indicates extraction of the integer part of |Xₘₐₓ/n|.

3. The buffer controller according to claim 2, wherein when n is the number of links through which data is to be transmitted that have data ready to be transmitted, the setting device recalculates the upper limit value when a readiness status indicating that one of the plurality of links has data ready to be transmitted changes.

4. The buffer controller according to claim 1, wherein the setting device sets the upper limit value according to the Equation:
Nₘₐₓ=Int|Xₘₐₓ/n| (If Xₘₐₓ<n, then Nₘₐₓ=1)
wherein Nₘₐₓ is the upper limit value, Xₘₐₓ is a total number of buffers to be allocated, n is either (1) the number of links through which data is to be transmitted, or (2) the number of links through which data is to be transmitted that have data ready to be transmitted, and Int|Xₘₐₓ/n| indicates extraction of the integer part of |Xₘₐₓ/n|; and
wherein any remainder of the division Xₘₐₓ/n is disregarded.

5. The buffer controller according to claim 4, wherein when n is the number of links through which data is to be transmitted that have data ready to be transmitted, the setting device recalculates the upper limit value when a readiness status indicating that one of the plurality of links has data ready to be transmitted changes.

6. The buffer controller according to claim 1, wherein the setting device sets the upper limit value according to the Equation:
Nₘₐₓ=Xₘₐₓ−X
wherein Nₘₐₓ is the upper limit value, Xₘₐₓ is a total number of buffers to be allocated, and x is an integer value greater than 0 and less than Xₘₐₓ.

7. The buffer controller according to claim 1, wherein the setting device recalculates the upper limit value when a new link is established.

8. The buffer controller according to claim 1, wherein the setting device recalculates the upper limit value when a link is disconnected.

9. A buffer controller for allocating buffers to a plurality of links, comprising:
a control device configured to allocate the buffers to data to be transmitted through each of the plurality of links; and
a setting device configured to set upper limit values for a number of buffers to be allocated for the plurality of links, wherein the setting device sets a first upper limit value for a first link of the plurality of links according to the Equation:
Nₘₐₓ=Xₘₐₓ−X;
wherein Nₘₐₓ is the first upper limit value, Xₘₐₓ is a total number of buffers to be allocated, and x is an integer value greater than 0 and less than Xₘₐₓ; and
wherein the setting device sets a second upper limit value for remaining links of the plurality of links according to one of the Equations:
Nₘₐₓ=Int|Xₘₐₓ/n|

(If Xₘₐₓ<n, then Nₘₐₓ=1), and
Nₘₐₓ=Int|Xₘₐₓ/n|+1
(If Xₘₐₓ<n, then Nₘₐₓ=1);
wherein Nₘₐₓ is the second upper limit value, Xₘₐₓ is a total number of buffers to be allocated, n is either (1) the number of links through which data is to be transmitted, or (2) the number of links through which data is to be transmitted that have data ready to be transmitted, and Int|Xₘₐₓ/n| indicates extraction of the integer part of |Xₘₐₓ/n|.

10. The buffer controller according to claim 9, wherein when n is the number of links through which data is to be transmitted that have data ready to be transmitted, the setting device recalculates at least the second upper limit value when a readiness status indicating that one of the plurality of links has data ready to be transmitted changes.

11. The buffer controller according to claim 9, wherein the setting device recalculates at least the second upper limit value when a new link is established.

12. The buffer controller according to claim 9, wherein the setting device recalculates at least the second upper limit value when a link is disconnected.

13. In a communication system including a host, a host controller, and a plurality of electronic devices, the host controller having a plurality of buffers for holding data to be transmitted from the host to the plurality of electronic devices through a plurality of links, a buffer controller for controlling allocation of the plurality of buffers to each of the plurality of links, comprising:
a setting device configured to set an upper limit value for a number of the plurality of buffers in the host controller to be allocated for each of the plurality of links; and
a control device configured to allocate the plurality of buffers to each of the plurality of links, the control device allocating the plurality of buffers within a range not greater than the upper limit value set by the setting device.

14. The buffer controller according to claim 13, wherein the setting device sets the upper limit value according to one of the Equations:
Nₘₐₓ=Int|Xₘₐₓ/n| (for Xₘₐₓ % n=0)
(If Xₘₐₓ<n, then Nₘₐₓ=1), and
Nₘₐₓ=Int|Xₘₐₓ/n|+1 (for Xₘₐₓ % n not=0)
(If Xₘₐₓ<n, then Nₘₐₓ=1);
wherein Nₘₐₓ is the upper limit value, Xₘₐₓ is a total number of allocable buffers in the host controller, n is either (1) the number of links through which data is to be transmitted, or (2) the number of links through which data is to be transmitted that have data ready to be transmitted, the operator % indicates obtaining the remainder of the division Xₘₐₓ/n, and Int|Xₘₐₓ/n| indicates extraction of the integer part of |Xₘₐₓ/n|.

15. The buffer controller according to claim 14, wherein when n is the number of links through which data is to be transmitted that have data ready to be transmitted, the setting device recalculates the upper limit value when a readiness status indicating that one of the plurality of links has data ready to be transmitted changes.

16. The buffer controller according to claim 13, wherein the setting device sets the upper limit value according to the Equation:
Nₘₐₓ=Int|Xₘₐₓ/n| (If Xₘₐₓ<n, then Nₘₐₓ=1)
wherein Nₘₐₓ is the upper limit value, Xₘₐₓ is a total number of allocable buffers in the host controller, n is either (1) the number of links through which data is to be transmitted, or (2) the number of links through which data is to be transmitted that have data ready to be transmitted, Int|Xₘₐₓ/n| indicates extraction of the integer part of |Xₘₐₓ/n|, and wherein any remainder of the division Xₘₐₓ/n is disregarded.

17. The buffer controller according to claim 16, wherein when n is the number of links through which data is to be transmitted that have data ready to be transmitted, the setting device recalculates the upper limit value when a readiness status indicating that one of the plurality of links has data ready to be transmitted changes.

18. The buffer controller according to claim 13, wherein the setting device sets the upper limit value according to the Equation:
Nₘₐₓ=Xₘₐₓ−X
wherein Nₘₐₓ is the upper limit value, Xₘₐₓ is a total number of buffers to be allocated, and x is an integer value greater than 0 and less than Xₘₐₓ.

19. The buffer controller according to claim 13, wherein the setting device recalculates the upper limit value when a new link is established.

20. The buffer controller according to claim 13, wherein the setting device recalculates the upper limit value when a link is disconnected.

21. In a communication system including a host, a host controller, and a plurality of electronic devices, the host controller having a plurality of buffers for holding data to be transmitted from the host to the plurality of electronic devices through a plurality of links, a buffer control method for controlling data allocation to the plurality of buffers, comprising the steps of:
setting an upper limit value for a number of the plurality of buffers in the host controller to be allocated for each of the plurality of links, and
controlling allocation of the plurality of buffers for each of the plurality of links such that the plurality of buffers are allocated within a range not greater than the upper limit value.

22. The buffer control method according to claim 21, wherein the setting step includes setting the upper limit value according to one of the Equations:
Nₘₐₓ=Int|Xₘₐₓ/n| (for Xₘₐₓ % n=0)
(If Xₘₐₓ<n, then Nₘₐₓ=1), and
Nₘₐₓ=Int|Xₘₐₓ/n+1 (for Xₘₐₓ % n not=0)
(If Xₘₐₓ<n, then Nₘₐₓ=1);
wherein Nₘₐₓ is the upper limit value, Xₘₐₓ is a total number of allocable buffers in the host controller, n is either (1) the number of links through which data is to be transmitted, or (2) the number of links through which data is to be transmitted that have data ready to be transmitted, the operator % indicates obtaining the remainder of the division Xₘₐₓ/n, and Int|Xₘₐₓ/n| indicates extraction of the integer part of |Xₘₐₓ/n|.

23. The buffer control method according to claim 22, wherein when n is the number of links through which data is to be transmitted that have data ready to be transmitted, the setting step includes recalculating the upper limit value when a readiness status indicating that one of the plurality of links has data ready to be transmitted changes.

24. The buffer control method according to claim 21, wherein the setting step includes setting the upper limit value according to the Equation:
Nₘₐₓ=Int|Xₘₐₓ/n| (If Xₘₐₓ<n, then Nₘₐₓ=1)
wherein Nₘₐₓ is the upper limit value, Xₘₐₓ is a total number of buffers to be allocated, n is either (1) the number of links through which data is to be transmitted, or (2) the number of links through which data is to be transmitted that have data ready to be transmitted, Int|Xₘₐₓ/n| indicates extraction of the integer part of |Xₘₐₓ/n|, and wherein any remainder of the division Xₘₐₓ/n is disregarded.

25. The buffer control method according to claim 24, wherein when n is the number of links through which data is to be transmitted that have data ready to be transmitted, the setting step includes recalculating the upper limit value when a readiness status indicating that one of the plurality of links has data ready to be transmitted changes.

26. The buffer control method according to claim 21, wherein the setting step includes setting the upper limit value according to the Equation:
Nₘₐₓ=Xₘₐₓ−X
wherein Nₘₐₓ is the upper limit value, Xₘₐₓ is a total number of buffers to be allocated, and x is an integer value greater than 0 and less than Xₘₐₓ.

27. In a communication system including a host, a host controller, and a plurality of electronic devices, the host controller having a plurality of buffers for holding data to be transmitted from the host to the plurality of electronic devices through a plurality of links, a buffer control method for controlling data allocation of a plurality of buffers, comprising the steps of:
setting upper limit values for a number of buffers to be allocated for the plurality of links, wherein a first upper limit value is set for a first link of the plurality of links according to the Equation:
Nₘₐₓ=Xₘₐₓ−x;
wherein Nₘₐₓ is the first upper limit value, Xₘₐₓ is a total number of buffers to be allocated, and x is an integer value greater than 0 and less than Xₘₐₓ; and
wherein a second upper limit value is set for remaining links of the plurality of links according to one of the Equations:
Nₘₐₓ=Int|Xₘₐₓ/n|

(If Xₘₐₓ<n, then Nₘₐₓ=1), and
Nₘₐₓ=Int|Xₘₐₓ/n|+1
(If Xₘₐₓ<n, then Nₘₐₓ=1);
wherein Nₘₐₓ is the second upper limit value, Xₘₐₓ is a total number of buffers to be allocated, n is either (1) the number of links through which data is to be transmitted, or (2) the number of links through which data is to be transmitted that have data ready to be transmitted, and Int|Xₘₐₓ/n| indicates extraction of the integer part of |Xₘₐₓ/n|.

28. The buffer control method according to claim 27, wherein when n is the number of links through which data is to be transmitted that have data ready to be transmitted, the setting step includes recalculating at least the second upper limit value when a readiness status indicating that one of the plurality of links has data ready to be transmitted changes.

29. The buffer control method according to claim 27, wherein the setting step includes recalculating at least the second upper limit value when a new link is established.

30. The buffer control method according to claim 27, wherein the setting step includes recalculating at least the second upper limit values when a link is disconnected.

31. A buffer controller for allocating buffers to a plurality of links, comprising:
means for dynamically setting an upper limit value for a number of buffers to be allocated for each of the plurality of links; and
means for allocating buffers to each of the plurality of links, the allocating means allocating a buffer within a range not greater than the upper limit value set by the setting means.

32. The buffer controller according to claim 31, wherein the setting means sets the upper limit value according to one of the Equations:
Nₘₐₓ=Int|Xₘₐₓ/n| (for Xₘₐₓ % n=0)
(If Xₘₐₓ<n, then Nₘₐₓ=1), and
Nₘₐₓ=Int|Xₘₐₓ/n|+1 (for Xₘₐₓ % n not=0)
(If Xₘₐₓ<n, then Nₘₐₓ=1);
wherein Nₘₐₓ is the upper limit value, Xₘₐₓ is a total number of buffers to be allocated, n is either (1) the number of links through which data is to be transmitted, or (2) the number of links through which data is to be transmitted that have data ready to be transmitted, the operator % indicates obtaining the remainder of the division Xₘₐₓ/n, and Int|Xₘₐₓ/n| indicates extraction of the integer part of |Xₘₐₓ/n|.

33. The buffer controller according to claim 32, wherein when n is the number of links through which data is to be transmitted that have data ready to be transmitted, the setting means recalculates the upper limit value when a readiness status indicating that one of the plurality of links has data ready to be transmitted changes.

34. The buffer controller according to claim 31, wherein the setting means sets the upper limit value according to the Equation:
Nₘₐₓ=Int|Xₘₐₓ/n| (If Xₘₐₓ<n, then Nₘₐₓ=1)
wherein Nₘₐₓ is the upper limit value, Xₘₐₓ is a total number of buffers to be allocated, n is either (1) the number of links through which data is to be transmitted, or (2) the number of links through which data is to be transmitted that have data ready to be transmitted, Int|Xₘₐₓ/n| indicates extraction of the integer part of |Xₘₐₓ/n|, and wherein any remainder of the division Xₘₐₓ/n is disregarded.

35. The buffer controller according to claim 34, wherein when n is the number of links through which data is to be transmitted that have data ready to be transmitted, the setting means recalculates the upper limit value when a readiness status indicating that one of the plurality of links has data ready to be transmitted changes.

36. The buffer controller according to claim 31, wherein the setting means sets the upper limit value according to the Equation:
Nₘₐₓ=Xₘₐₓ−x
p1 wherein Nₘₐₓ is the upper limit value, Xₘₐₓ is a total number of buffers to be allocated, and x is an integer value greater than 0 and less than Xₘₐₓ.

37. The buffer controller according to claim 31, wherein the setting means recalculates the upper limit value when a new link is established.

38. The buffer controller according to claim 31, wherein the setting means recalculates the upper limit value when a link is disconnected.
